(19) United States
(12) Patent Application Publication
(10) Pub. No.: US 2020/0310873 A1
(43) Pub. Date: Oct. 1, 2020

(54) CONTROLLER AND MEMORY SYSTEM INCLUDING THE SAME

(71) Applicant: SK hynix Inc., Icheon (KR)

(72) Inventor: Jong-Min LEE, Seoul (KR)

(21) Appl. No.: 16/773,791

(22) Filed: Jan. 27, 2020

(30) Foreign Application Priority Data
Mar. 27, 2019 (KR) 10-2019-0035007

(51) Int. Cl. G06F 9/48; G06F 9/54; G06F 9/38; G06F 12/02; G06F 11/10; G06F 13/16

(52) U.S. Cl. CPC G06F 9/4893; G06F 9/544; G06F 9/546; G06F 2212/7201; G06F 12/0246; G06F 11/1044; G06F 13/1673; G06F 9/3834

(57) ABSTRACT

A controller for controlling a memory device, the controller includes a plurality of sub operation blocks suitable for performing sub operations of a request in a pipelining scheme; a plurality of queues respectively corresponding to the plurality of sub operation blocks and suitable for queuing a plurality of requests that are associated with the sub operations; and a pipeline manager suitable for selectively enabling each of the plurality of queues based on available power.

### CROSS-REFERENCE TO RELATED APPLICATION

This application claims priority under 35 U.S.C. § 119 to Korean Patent Application No. 10-2019-0035007 filed on Mar. 27, 2019, which is incorporated herein by reference in its entirety.

### BACKGROUND

### 1. Field

Embodiments relate to a controller for controlling a memory device and a memory system including the controller.

### 2. Discussion of the Related Art

Recently, the paradigm for the computer environment moves toward ubiquitous computing in which computer systems can be used anytime and everywhere. In the era of ubiquitous computing, the demand for portable electronic devices, such as mobile phones, digital cameras, laptop computers, and so on, has rapidly increased. In general, such a portable electronic device uses a memory system including a memory device as a data storage device. The data storage device may be used as a main memory device or an auxiliary memory device of the portable electronic device.

Since a data storage device using a nonvolatile memory device does not have a mechanical driving part unlike a hard disk, it may have excellent stability and durability, a high data access speed, and low power consumption. The data storage device having such advantages includes any of a universal serial bus (USB) memory device, a memory card having various interfaces, a solid state drive (SSD), and so on.

### SUMMARY

Various embodiments are directed to a controller capable of dynamically adjusting the performance of a read operation and power consumption depending on available power, and to a memory system including the controller.

The disclosure provides a controller and a memory system.

In an embodiment, a controller for controlling a memory device, the controller may include: a plurality of sub operation blocks suitable for performing sub operations of a request in a pipelining scheme; a plurality of queues respectively corresponding to the plurality of sub operation blocks and suitable for queuing a plurality of requests that are associated with the sub operations; and a pipeline manager suitable for selectively enabling each of the plurality of queues based on available power.

In an embodiment, a memory system may include: a memory device; and a controller suitable for controlling the memory device, wherein the controller including a plurality of sub operation blocks suitable for performing sub operations of a request in a pipelining scheme; a plurality of queues respectively corresponding to the plurality of sub operation blocks and suitable for queuing a plurality of requests that are associated with the sub operations; and a pipeline manager suitable for selectively enabling each of the plurality of queues based on available power.

According to the embodiments, it is possible to provide a controller capable of dynamically adjusting the performance of a read operation and a power consumption amount depending on available power, and a memory system including the controller.

Effects obtainable from the disclosure may be non-limited by the above mentioned effect. Other unmentioned effects may be clearly understood from the following description by those having ordinary skill in the technical field to which the disclosure pertains.

### BRIEF DESCRIPTION OF THE DRAWINGS

FIG. 1 illustrates a data processing system including a memory system in accordance with an embodiment.

FIG. 2 illustrates a memory system in accordance with an embodiment.

FIGS. 3A and 3B illustrate pipelining stages adjusted by a queue manager in accordance with an embodiment.

FIG. 4 is a timing diagram illustrating operations of sub operation blocks in accordance with an embodiment.

FIG. 5 is a timing diagram illustrating operations of sub operation blocks in accordance with another embodiment.

FIG. 6 is a flow chart illustrating an operation of a controller in accordance with an embodiment.

### DETAILED DESCRIPTION

Various embodiments will be described below in more detail with reference to the accompanying drawings. Embodiments of the present disclosure may, however, be embodied in different forms and should not be construed as limited to the embodiments set forth herein. Rather, the embodiments set forth herein are provided so that this disclosure will be thorough and complete, and will fully convey the scope of the present disclosure to those skilled in the art. Throughout the disclosure, like reference numerals refer to like parts throughout the various figures and embodiments of the present disclosure.

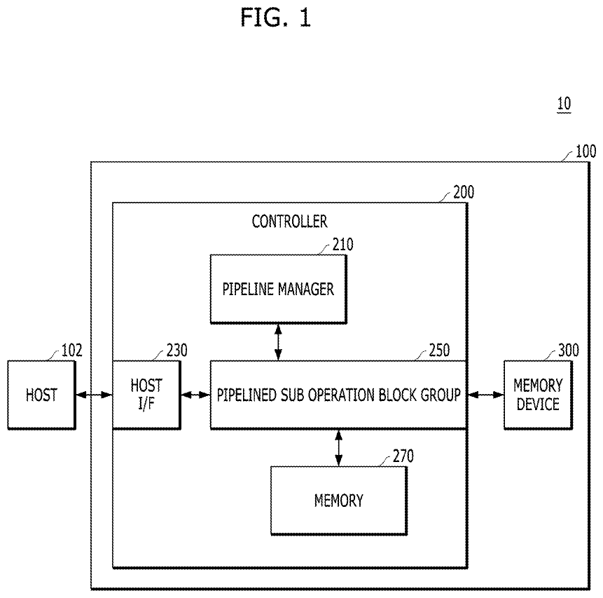

FIG. 1 illustrates a data processing system 10 in accordance with an embodiment.

Referring to FIG. 1, the data processing system 10 includes a host 102 and a memory system 100.

The host 102 may include a portable electronic device such as a mobile phone, an MP3 player, a laptop computer, or the like, or an electronic device such as a desktop computer, a game player, a TV, a projector, or the like.

The memory system 100 may operate to store data for the host 102 in response to a request of the host 102. For example, the memory system 100 may be realized into any one of various kinds of storage devices including a solid state drive (SSD), a multimedia card in the form of an MMC, an eMMC (embedded MMC), an RS-MMC (reduced size MMC), or a micro-MMC, a secure digital card in the form of an SD, a mini-SD, or a micro-SD, a universal serial bus (USB) storage device, a universal flash storage (UFS) device, a compact flash (CF) card, a smart media card, a memory stick, and so forth.

The memory system 100 may be realized by various types of memory devices. For example, the memory devices may include a volatile memory device, such as a dynamic random access memory (DRAM) or a static random access memory (SRAM), and a nonvolatile memory device, such as a read only memory (ROM), a mask ROM (MROM), a programmable ROM (PROM), an erasable programmable ROM (EPROM), an electrically erasable and programmable ROM (EEPROM), a ferromagnetic random access memory (FRAM), a phase change RAM (PRAM), a magnetic RAM (MRAM), a resistive RAM (RRAM), or a flash memory. The flash memory may have a three-dimensional stack structure.

The memory system 100 may include a memory device 300 and a controller 200. The memory device 300 may store data for the host 102, and the controller 200 may control operations of the memory device 300.

The controller 200 and the memory device 300 may be integrated into one semiconductor device. For instance, the controller 200 and the memory device 300 may be integrated into one semiconductor device to thereby configure an SSD. If the memory system 100 is used as an SSD, an operating speed of the host 102 which is coupled to the memory system 100 may be improved.

In addition, the controller 200 and the memory device 300 may be integrated into one semiconductor device to thereby configure a memory card. For example, the controller 200 and the memory device 300 may configure a memory card such as a PC card (PCMCIA: Personal Computer Memory Card International Association), a compact flash card (CF), a smart media card (SM or SMC), a memory stick, a multimedia card (MMC, RS-MMC, or MMCmicro), an SD card (SD, miniSD, microSD, or SDHC), a universal flash storage (UFS), or the like.

The memory device 300 may include a plurality of nonvolatile memory cells. The plurality of nonvolatile memory cells may have a string structure. A set of memory cells having a string structure is referred to as a memory cell array. A memory cell array of the memory device 300 may be configured by a plurality of memory blocks. Each memory block may be configured by a plurality of pages. Each page may be configured by a plurality of memory cells which share one word line. The memory device 300 may perform an erase operation by the unit of memory block, and may perform read and program (or write) operations by the unit of page.

The memory device 300 may provide a faster read speed and a relatively low unit cost as compared to other memory devices. However, because the memory device 300 does not perform an overwrite operation, an erase operation needs to be performed prior to writing data in the memory device 300. Also, the unit of erasing data is larger than the unit of writing data in the memory device 300. When the memory device 300 is used as a memory device of the host 102, a file system for a hard disk cannot be utilized as it is, due to the erase characteristic.

The memory device 300 implemented with a nonvolatile memory device may maintain data stored therein even though power is not supplied. However, if data stored in the memory device 300 is frequently read or power is not supplied to the memory device 300 for a long time, the data stored in the memory device 300 may be distorted.

In order to overcome limitations in terms of the performance and reliability of the memory device 300, the controller 200 may store data in the memory device 300 and read data from the memory device 300 by performing various operations in response to requests of the host 102.

For example, in order to write data in the memory device 300, the controller 200 may map a logical address of the host 102 to a physical address of the memory device 300. The controller 200 may store write data in the memory device 300 with parity bits by performing an error correction code (ECC) encoding operation on the write data.

In order to read data from the memory device 300, the controller 200 may access the memory device 300 by translating a logical address from the host 102 into a physical address with reference to map data of the memory system 100. The controller 200 may detect and correct an error of the read data by performing an ECC decoding operation on the read data using parity bits corresponding to the read data, and provide the error-corrected read data to the host 102.

That is, in response to a read request from the host 102, the controller 200 may perform a plurality of sub operations such as an address translation operation, an operation of reading data from the memory device 300, an ECC decoding operation, and so forth.

The controller 200 may include a pipeline manager 210, a host interface (I/F) 230, a pipelined sub operation block group 250, and a memory 270.

The controller 200 may include the pipelined sub operation block group 250 which performs sub operations included in at least some requests. The pipelined sub operation block group 250 may include a plurality of sub operation blocks. In an embodiment, each of the sub operation blocks of the pipelined sub operation block group 250 may be realized by a hardware device such as a field programmable gate array (FPGA). In another embodiment, firmware which performs each of the sub operations may be stored in a corresponding one of the sub operation blocks.

The pipelined sub operation block group 250 may further include queues respectively corresponding to the sub operation blocks. For example, a first queue may receive and queue a first input signal for a first sub operation block of the sub operation blocks in the pipelined sub operation block group 250. The first sub operation block may execute a first request corresponding to the first input signal transferred from the first queue and provide an output signal of the execution of the first request to a second queue when the first request is completely executed. After that, the second queue may receive the output signal from the first sub operation block and queue the output signal as an input signal for a second sub operation block. The second sub operation block may execute a request corresponding to the input signal transferred from the second queue, and at the same time, the first sub operation block may execute a second request corresponding to a second input signal queued in the first queue. The controller 200 may process a plurality of requests in a pipelining scheme by simultaneously driving the plurality of sub operation blocks to process the plurality of requests.

The host interface 230 processes a request and data from the host 102, and communicates with the host 102 using at least one of various interface protocols including universal serial bus (USB), multimedia card (MMC), peripheral component interconnect-express (PCI-E), serial attached SCSI (SAS), serial advanced technology attachment (SATA), parallel advanced technology attachment (PATA), small computer system interface (SCSI), enhanced small disk interface (ESDI), integrated drive electronics (IDE), mobile industry processor interface (MIPI), and so on. The host interface 230 may receive a request from the host 102 and provide the received request to the pipelined sub operation block group 250.

The memory 270 may play the role of a working memory of the memory system 100 and the controller 200, and may store data for driving the memory system 100 and the controller 200. The controller 200 may control the memory device 300 in such a manner that the memory device 300 performs read, write, and erase operations in response to requests from the host 102. The controller 200 may provide data read from the memory device 300 to the host 102, and may store data provided by the host 102 in the memory device 300. The memory 270 may store data necessary for performing operations of the controller 200 and the memory device. For example, the memory 270 may be electrically coupled with the sub operation blocks of the pipelined sub operation block group 250, and may store data necessary for performing operations of the sub operation blocks.

If the controller 200 processes a plurality of requests in the pipelining scheme, a plurality of sub operation blocks may be simultaneously driven in response to the plurality of requests. Since sub operations of the plurality of requests are simultaneously processed by the plurality of sub operation blocks, the throughput of the memory system 100 may increase. However, if the plurality of sub operation blocks are simultaneously driven in response to the plurality of requests, the power consumption of the controller 200 may increase.

The controller 200 may dynamically change the number of pipelining stages by selectively enabling or disabling corresponding queues of the respective sub operation blocks based on available power of the memory system 100. According to the embodiment of the disclosure, as the controller 200 dynamically changes the number of pipelining stages based on the available power, the throughput and power consumption of the memory system 100 may be dynamically adjusted.

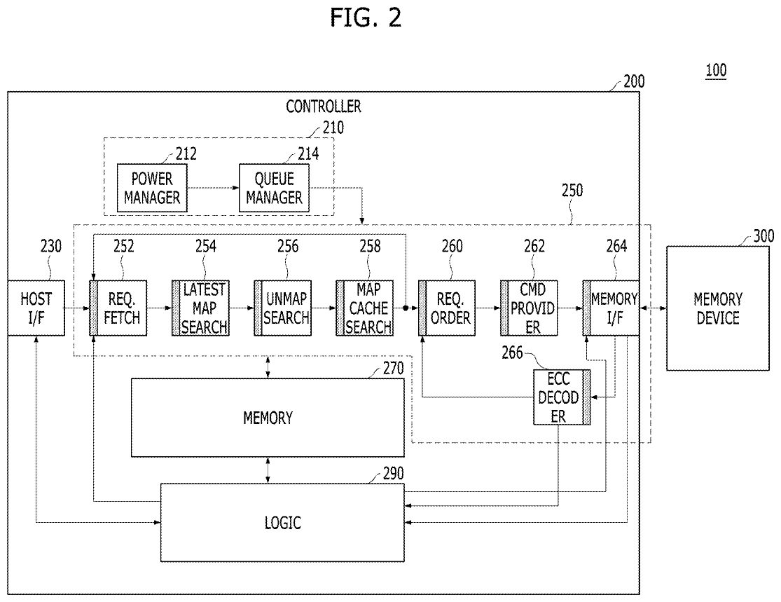

FIG. 2 illustrates the memory system 100 of FIG. 1 in accordance with an embodiment. A controller 200 and a memory device 300 of FIG. 2 respectively correspond to those described above with reference to FIG. 1.

FIG. 2 illustrates a case where the controller 200 includes a sub operation block group 250 which performs sub operations included in a read request. A pipeline manager 210, a host interface (I/F) 230, the sub operation block group 250, and a memory 270 of FIG. 2 respectively correspond to those described above with reference to FIG. 1. In an embodiment, the controller 200 may further include a logic block 290.

The logic block 290 may control entire operations of the memory system 100 except a request processed by the sub operation block group 250. The logic block 290 may drive firmware to control the entire operations of the memory system 100. The logic block 290 may include a microprocessor or a central processing unit (CPU).

The logic block 290 may perform a foreground operation as an operation corresponding to a request received from the host 102 of FIG. 1. For example, the logic block 290 may perform a write operation corresponding to a write request, an erase operation corresponding to an erase request, a parameter set operation corresponding to a parameter set request or a feature set request, and so forth.

For example, when a write request is received from the host interface 230, the logic block 290 may perform an ECC encoding operation on write data, and thereby generate parity bits corresponding to the write data. The logic block 290 may provide a write command for storing the write data and the parity bits to a memory interface (I/F) 264 which will be described below. The logic block 290 may update map data corresponding to the write data stored in the memory device 300.

The logic block 290 may also perform a background operation. The background operation for the memory device 300 may include a garbage collection (GC) operation, a wear leveling (WL) operation, a map flush operation, a bad block management operation, or the like.

According to an embodiment, the sub operation block group 250 may include, as sub operation blocks for performing a read operation including the sub operations included in the read request, a request fetch circuit 252, a latest map search circuit 254, an unmap search circuit 256, a map cache search circuit 258, a request order circuit 260, a command (CMD) provider 262, the memory interface 264, and an ECC decoder 266.

The respective sub operation blocks shown in FIG. 2 are for an illustrative purpose only. According to other embodiments, at least two sub operation blocks illustrated in FIG. 2 may be merged to one sub operation block, or one sub operation block may be divided into at least two sub operation blocks. In an embodiment, the sub operation block group 250 may further include sub operation blocks for performing a write operation including sub operations included in a write request.

The sub operation block group 250 may include queues corresponding to the respective sub operation blocks. In FIG. 2, a shaded portion in each sub operation block represents a corresponding queue.

The host interface 230 may receive the read request and a logical address from the host 102 and provide the read request and the logical address to the corresponding queue of the request fetch circuit 252. The logic block 290 may provide a read request generated therein to the corresponding queue of the request fetch circuit 252.

In order to execute the read request received through the corresponding queue, the request fetch circuit 252 may fetch and decode an instruction of the read request which is stored in the memory 270. The request fetch circuit 252 may provide a latest map data search request and the logical address corresponding to the read request to the corresponding queue of the latest map search circuit 254 in response to the decoded instruction.

Meanwhile, in order not to lose map data, the logic block 290 may store the map data in the memory device 300 that includes a nonvolatile memory device. A time for the logic block 290 to access the memory device 300 may be longer than a time for the logic block 290 to access the memory 270. In order to quickly process map data, the logic block 290 may first store recently generated map data in a latest map list of the memory 270 and then reflect the recently generated map data on the map data stored in the memory device 300 at predetermined intervals. The logic block 290 may store map data to be removed in an unmap list of the memory 270 and then perform an unmap operation on the map data to be removed at predetermined intervals. The logic block 290 may load frequently accessed map data from the memory device 300 and cache the frequently accessed map data in a map cache of the memory 270. The latest map search circuit 254, the unmap search circuit 256, and the map cache search circuit 258 may perform a sequence of operations of searching for a physical address that corresponds to the logical address corresponding to the read request from the latest map list, the unmap list, and the map cache of the memory 270.

The latest map search circuit 254 may check whether map data of the logical address exists in the latest map list of the memory 270 in response to the latest map data search request and the logical address received through the corresponding queue. When the map data of the logical address exists in the latest map list, the latest map search circuit 254 may provide a physical address corresponding to the logical address to the corresponding queue of the unmap search circuit 256 based on the map data of the logical address. When the map data of the logical address does not exist in the latest map list, the latest map search circuit 254 may provide the logical address and an unmap search request to the corresponding queue of the unmap search circuit 256.

When the unmap search request and the logical address are received through the corresponding queue, the unmap search circuit 256 may check whether the map data of the logical address exists in the unmap list in response to the unmap search request. When the map data of the logical address exists in the unmap list, the unmap search circuit 256 may provide a physical address corresponding to the logical address to the corresponding queue of the map cache search circuit 258 based on the map data of the logical address. When the map data of the logical address does not exist in the unmap list, the unmap search circuit 256 may provide the logical address and a map cache search request to the corresponding queue of the map cache search circuit 258.

On the other hand, when the physical address is received through the corresponding queue, the unmap search circuit 256 may provide the physical address to the corresponding queue of the map cache search circuit 258.

When the map cache search request and the logical address are received from the corresponding queue, the map cache search circuit 258 may check whether the map data of the logical address exists in the map cache in response to the map cache search request. When the map data of the logical address exists in the map cache, the map cache search circuit 258 may provide a physical address corresponding to the logical address and a read request to the corresponding queue of the request order circuit 260 based on the map data of the logical address.

On the other hand, when the physical address is received through the corresponding queue, the map cache search circuit 258 may provide the physical address corresponding to the logical address and the read request to the corresponding queue of the request ordering circuit 260.

When the map data of the logical address does not exist in the map cache, the map cache search circuit 258 may provide a map data read request for loading the map data from the memory device 300 and a physical address of a memory region storing the map data of the logical address to the corresponding queue of the request order circuit 260. The map cache search circuit 258 may also provide a cause read request and the logical address to the corresponding queue of the request fetch circuit 252. The cause read request refers to a read request that is a cause of making the map cache search circuit 258 search for the map data.

The request order circuit 260 may arrange an execution order of at least one read request received from the corresponding queue. In an embodiment, the request order circuit 260 may arrange an execution order of read requests based on physical addresses corresponding to the read requests to thereby maximize the read performance of the memory device 300. For example, the request order circuit 260 may arrange the execution order of the read requests such that the memory device 300 may perform a one-shot read operation or perform a parallel read operation in multiple planes of the memory device 300. The request order circuit 260 may provide a read request and a corresponding physical address to the corresponding queue of the command provider 262 according to an arranged execution order.

The command provider 262 may generate a read command for the memory device 300 based on the read request and the physical address received from the corresponding queue. The command provider 262 may provide the read command and the physical address to the corresponding queue of the memory interface 264.

The memory interface 264 may play the role of a memory/storage interface for providing an interface between the controller 200 and the memory device 300, so that the controller 200 controls the memory device 300 in response to a request from the host 102. The memory interface 264 may operate as an interface for processing a command and data between the controller 200 and the memory device 300. For example, the memory interface 264 may be a NAND flash interface.

The corresponding queue of the memory interface 264 may queue a command from the logic block 290 or the read command from the command provider 262. The memory interface 264 may control an operation of the memory device 300 in response to the command received from the corresponding queue.

The memory interface 264 may control a read operation of the memory device 300 based on the read command and the physical address received from the corresponding queue. The memory interface 264 may store data read from the memory device 300 in the memory 270. The memory interface 264 may provide an ECC decoding request for the read data to the corresponding queue of the ECC decoder 266.

The memory interface 264 may control not only a read operation but also a program operation of the memory device 300. In an embodiment, the logic block 290 may map a logical address to a physical address in response to a write request, generate a program command, and provide the program command to the corresponding queue of the memory interface 264. The memory interface 264 may control the program operation of the memory device 300 in response to the program command received from the corresponding queue.

The ECC decoder 266 may detect and correct an error of the read data stored in the memory 270 in response to the ECC decoding request received from the corresponding queue. The read data may include parity bits, and the ECC decoder 266 may detect and correct an error of the read data by performing an ECC decoding operation on the read data with the parity bits.

If the correction for the error of the read data succeeds, the ECC decoder 266 may store the error-corrected data in the memory 270, and may provide a data output request to the logic block 290. The logic block 290 may provide the error-corrected data to the host 102 through the host interface 230.

If the number of bits of the error of the read data exceeds a correctable number of bits, the ECC decoder 266 cannot correct the error of the read data, and may provide the read request and the physical address corresponding to the read data to the corresponding queue of the request order circuit 260 to read again the read data.

The pipeline manager 210 may dynamically adjust the throughput and power consumption of the memory system 100 by dynamically changing the number of pipelining stages based on available power.

The pipeline manager 210 may include a power manager 212 and a queue manager 214.

The power manager 212 may determine available power of the memory system 100. In an embodiment, the power manager 212 may detect power supply and power consumption of the memory system 100. The power manager 212 may determine the available power based on the power supply and the power consumption.

The queue manager 214 may dynamically adjust the number of pipelining stages by selectively enabling the queues of the sub operation blocks in the sub operation block group 250. For example, the queue manager 214 may dynamically adjust the number of pipelining stages by enabling the same number of queues as the number of the pipelining stages among the queues of the sub operation blocks in the sub operation block group 250. The queues of the sub operation blocks in the sub operation block group 250 may be selectively enabled or disabled in response to an enable or disable signal from the queue manager 214.

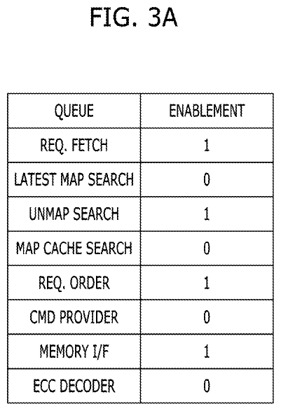

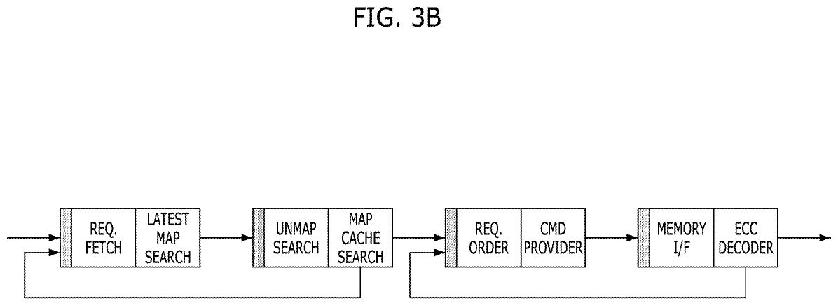

FIGS. 3A and 3B illustrate pipelining stages adjusted by the queue manager 214 of FIG. 2.

FIG. 3A is a table indicating whether the queues of the sub operation blocks in the sub operation block group 250 are enabled or not. The table of FIG. 3A illustrates the sub operation blocks depending on an order of performing their operations. Referring to the table of FIG. 3A, the queue manager 214 may enable the corresponding queues of the request fetch circuit 252, the unmap search circuit 256, the request order circuit 260, and the memory interface 264, and may disable the corresponding queues of the latest map search circuit 254, the map cache search circuit 258, the command provider 262, and the ECC decoder 266.

If a queue is enabled, the queue may receive input signals, queue the input signals, and transfer the input signals to a corresponding sub operation block in a queued order. If a queue is disabled, the queue may directly transfer the input signals to the corresponding sub operation block without queuing the input signals.

FIG. 3B illustrates pipelining stages when the corresponding queues of the sub operation blocks in the sub operation block group 250 are enabled or disabled as illustrated in the table of FIG. 3A. Shaded portions in the sub operation blocks of FIG. 3B represent enabled queues.

Since the queue of the request fetch circuit 252 is enabled, the enabled queue may queue input signals. Since the queue of the latest map search circuit 254 is disabled, the disabled queue cannot queue the input signals from the request fetch circuit 252, and thus may directly transfer the input signals to the latest map search circuit 254.

The request fetch circuit 252 may fetch, in response to a queued read request, a read instruction for the queued read request, may provide a latest map data search request to the corresponding queue of the latest map search circuit 254, and may fetch a read instruction for a next queued read request after the latest map data search request provided to the latest map search circuit 254 is completely executed by the latest map search circuit 254 and thus a physical address corresponding to a logical address or an unmap search request is provided to the corresponding queue of the unmap search circuit 256. That is to say, as the queue manager 214 disables the corresponding queue of the latest map search circuit 254, the request fetch circuit 252 and the latest map search circuit 254 may be integrated.

Similarly, the queue manager 214 may integrate the unmap search circuit 256 and the map cache search circuit 258, the request order circuit 260 and the command provider 262, and the memory interface 264 and the ECC decoder 266, respectively. In FIG. 3B, sub operation blocks, which adjoin each other, are integrated with each other, and arrows between integrated blocks represent signal input/output paths between the integrated blocks.

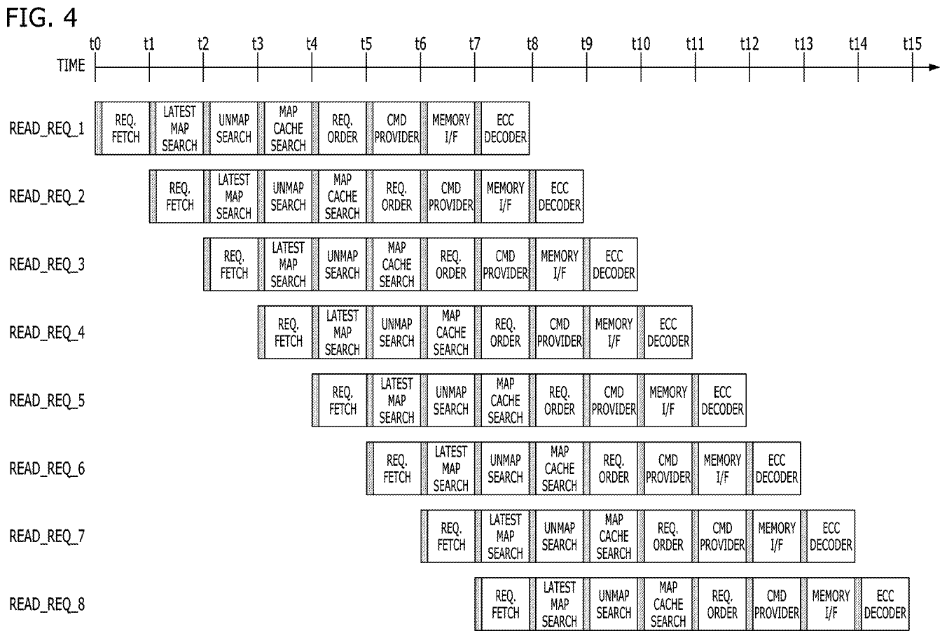

FIG. 4 is a timing diagram illustrating operations of the sub operation blocks in the sub operation block group 250 of FIG. 2 in accordance with an embodiment.

The horizontal axis of FIG. 4 represents the flow of time. FIG. 4 illustrates the sub operation blocks operating in the pipelining scheme with the lapse of time when all the corresponding queues of the sub operation blocks are enabled. In other words, in FIG. 4, the number of pipelining stages of the sub operation block group 250 is the same as the number of sub operation blocks in the sub operation block group 250. That is, in FIG. 4, the number of pipelining stages is eight. The timing diagram of FIG. 4 will be described with reference to FIG. 2.

When the host interface 230 provides eight read requests READ_REQ_1 to READ_REQ_8 to the sub operation block group 250 at a time t0, the received read requests READ_REQ_1 to READ_REQ_8 may be queued in the corresponding queue of the request fetch circuit 252. The request fetch circuit 252 may fetch a read instruction to execute the first read request READ_REQ_1 till a time t1. The request fetch circuit 252 may provide a latest map data search request and a logical address corresponding to the first read request READ_REQ_1 to the corresponding queue of the latest map search circuit 254 at the time t1 in order to execute the first read request READ_REQ_1.

In a period from the time t1 to a time t2, the latest map search circuit 254 searches a latest map list to execute the first read request READ_REQ_1, and the request fetch circuit 252 may fetch a read instruction to execute the second read request READ_REQ_2.

In a period from the time t2 to a time t3, the unmap search circuit 256 may search an unmap list to execute the first read request READ_REQ_1, the latest map search circuit 254 may search the latest map list to execute the second read request READ_REQ_2, and the request fetch circuit 252 may fetch a read instruction to execute the third read request READ_REQ_3.

Namely, the respective sub operation blocks may simultaneously operate in the pipelining scheme, and may perform operations corresponding to a plurality of read requests at the same time. In FIG. 4, all the sub operation blocks may simultaneously operate to execute the eight read requests READ_REQ_1 to READ_REQ_8 in a period from a time t7 to a time t8. If all the sub operation blocks operate simultaneously, the throughput of a read operation may increase. Therefore, the queue manager 214 may increase the throughput of the read operation by enabling the corresponding queues of all the sub operation blocks in the sub operation block group 250 when available power is sufficient.

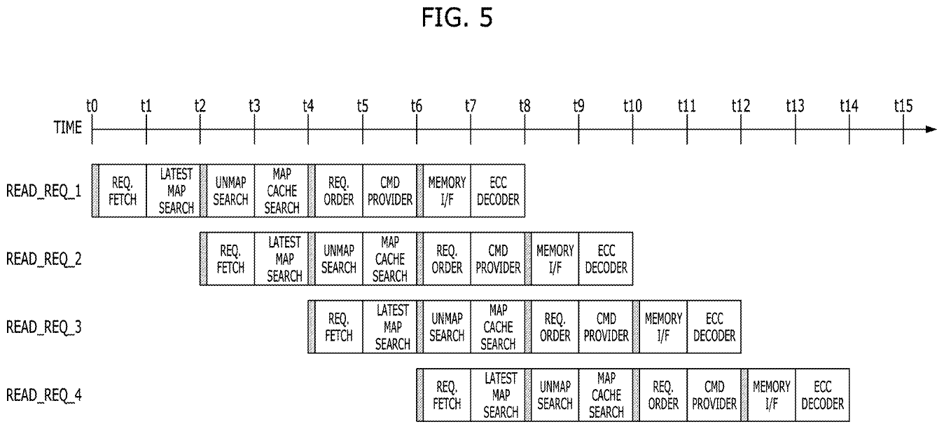

FIG. 5 is a timing diagram illustrating operations of the sub operation blocks in the sub operation block group 250 of FIG. 2 in accordance with another embodiment.

The horizontal axis of FIG. 5 represents the flow of time. FIG. 5 illustrates the sub operation blocks operating in the pipelining scheme with the lapse of time when only some of the corresponding queues of the sub operation blocks are enabled as illustrated in the table of FIG. 3A. In FIG. 5, the number of pipelining stages of the sub operation block group 250 is four.

Four read requests READ_REQ_1 to READ_REQ_4 may be received from the host interface 230 at a time t0, and the received four read requests READ_REQ_1 to READ_REQ_4 may be queued in the corresponding queue of the request fetch circuit 252. The request fetch circuit 252 may fetch a read instruction to execute the first read request READ_REQ_1 till a time t1. After that, the request fetch circuit 252 may provide a latest map data search request and a logical address corresponding to the first read request READ_REQ_1 to the corresponding queue of the latest map search circuit 254 at the time t1 in order to execute the first read request READ_REQ_1.

Since the corresponding queue of the latest map search circuit 254 is disabled, the latest map data search request may be directly transferred to the latest map search circuit 254 without being queued. The latest map search circuit 254 may search a latest map list to execute the first read request READ_REQ_1 during a period from the time t1 to a time t2. Since the request fetch circuit 252 and the latest map search circuit 254 are integrated, the request fetch circuit 252 may not operate while the latest map search circuit 254 operates. The latest map search circuit 254 may provide a physical address corresponding to the logical address or an unmap data search request to the corresponding queue of the unmap search circuit 256 at the time t2.

After the latest map search circuit 254 provides the physical address or the unmap data search request to the corresponding queue of the unmap search circuit 256, in a period from the time t2 to a time t3, the unmap search circuit 256 may search an unmap list to execute the first read request READ_REQ_1 in response to the unmap data search request received from the corresponding queue. At the same time, the request fetch circuit 252 may fetch a read instruction to execute the second read request READ_REQ_2. However, the latest map search circuit 254 which is integrated with the request fetch circuit 252 may not operate while the request fetch circuit 252 operates, i.e., in the period from the time t2 to the time t3.

Similarly, each of the unmap search circuit 256 and the map cache search circuit 258, the request order circuit 260 and the command provider 262, and the memory interface 264 and the error correction decoder 266, which are integrated, may operate similar to the request fetch circuit 252 and the latest map search circuit 254 that are integrated and operate as one pipelining stage.

Referring to FIG. 5, when the sub operation block group 250 has the four pipelining stages and operates in the pipelining scheme, maximum four sub operation blocks may operate simultaneously. For example, in a period from a time t6 to a time t7, the request fetch circuit 252, the unmap search circuit 256, the request order circuit 260, and the memory interface 264, which are respectively included in the four pipelining stages, operate simultaneously. In a period from the time t7 and a time t8, the latest map search circuit 254, the map cache search circuit 258, the command provider 262, and the ECC decoder 266, which are respectively included in the four pipelining stages, operate simultaneously.

In the case where the corresponding queues of some of the sub operation blocks in the sub operation block group 250 are enabled, power consumption may be reduced as compared to the case where the corresponding queues of all the sub operation blocks in the sub operation block group 250 are enabled. The queue manager 214 may reduce the power consumption of the read operation by enabling the corresponding queues of some of the sub operation blocks when the available power is insufficient.

As illustrated in FIGS. 4 and 5, the queue manager 214 can dynamically change the number of enabled queues based on the available power, and also select queues to be enabled.

For example, the queue manager 214 may enable only the corresponding queues of the request fetch circuit 252 and the request order circuit 260. In this case, the request fetch circuit 252, the latest map search circuit 254, the unmap search circuit 256, and the map cache search circuit 258 may be integrated in one pipelining stage, and the request order circuit 260, the command provider 262, the memory interface 264, and the error correction decoder 266 may be integrated in another pipelining stage. For another example, the queue manager 214 may enable only the corresponding queue of the request fetch circuit 252 depending on the available power. That is to say, the queue manager 214 may minimize the power consumption by integrating all the sub operation blocks in one pipelining stage, so that only one of the sub operation blocks executes a corresponding request in each time period of FIG. 4 or 5.

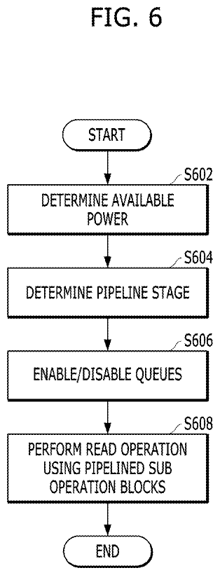

FIG. 6 is a flow chart illustrating an operation of the controller 200 of FIG. 2 in accordance with an embodiment. The operation of the controller 200 will be described with reference to FIG. 2.

At S602, the power manager 212 may determine available power. For example, the power manager 212 may detect power supplied to the memory system 100 and power consumed in the logic block 290, and may determine the available power based on the supplied power and the consumed power.

At S604, the power manager 212 may determine the number of pipelining stages based on the available power. For example, the power manager 212 may determine a larger number of pipelining stages as the available power increases. The power manager 212 may provide information on the number of pipelining stages to the queue manager 214.

At S606, the queue manager 214 may selectively enable the corresponding queues of the sub operation blocks in the sub operation block group 250 based on the information on the number of pipelining stages. As illustrated in FIGS. 2 to 3B and FIG. 5, in the case where the sub operation block group 250 includes the eight sub operation blocks and the information on the number of pipelining stages which is received by the queue manager 214 represents four pipelining stages, the queue manager 214 may enable only corresponding queues of four sub operation blocks in the sub operation block group 250 and may disable corresponding queues of the remaining four sub operation blocks in the sub operation block group 250.

At S608, the sub operation block group 250 may perform a read operation by using the sub operation blocks operating in the pipelining scheme. As the number of enabled queues increases and thus the number of pipelining stages increases, the throughput of the read operation of the sub operation block group 250 may increase and the power consumption of the read operation of the sub operation block group 250 may also increase. On the other hand, as the number of enabled queues decreases and thus the number of pipelining stages decreases, the power consumption of the read operation of the sub operation block group 250 may decrease and the throughput of the read operation of the sub operation block group 250 may also decrease.

According to the embodiments of the disclosure, the controller 200 may include the sub operation block group 250 which operates in the pipelining scheme in response to a plurality of requests. The sub operation block group 250 may include a plurality of sub operation blocks, each of which includes a corresponding queue. The controller 200 may further include the pipeline manager 210. The pipeline manager 210 may dynamically change the number of pipelining stages of the sub operation block group 250 by selectively enabling the corresponding queues of the plurality of sub operation blocks based on available power.

According to the embodiments of the disclosure, as the controller 200 includes the sub operation block group 250 which executes a plurality of requests in the pipelining scheme, the throughput of the memory system 100 may be improved.

According to the embodiments of the disclosure, the controller 200 may adjust power consumption depending on operations to be performed by requests by dynamically changing the number of pipelining stages of the sub operation block group 250.

Although various embodiments have been described for illustrative purposes, it will be apparent to those skilled in the art that various changes and modifications may be made without departing from the spirit and scope of the invention as defined in the following claims.

What is claimed is:

1. A controller for controlling a memory device, the controller comprising:
a plurality of sub operation blocks suitable for performing sub operations of a request in a pipelining scheme;
a plurality of queues respectively corresponding to the plurality of sub operation blocks and suitable for queuing a plurality of requests that are associated with the sub operations; and
a pipeline manager suitable for selectively enabling each of the plurality of queues based on available power.

2. The controller according to claim 1, wherein each of the plurality of queues queues an input signal in response to an enable signal from the pipeline manager, and transfers the input signal to a corresponding sub operation block among the plurality of sub operation blocks.

3. The controller according to claim 1, wherein each of the plurality of queues directly transfers an input signal to a corresponding sub operation block without queuing the input signal in response to a disable signal from the pipeline manager.

4. The controller according to claim 1, wherein the available power is determined based on power supply and power consumption.

5. The controller according to claim 1, further comprising:
a memory,
wherein the plurality of sub operation blocks comprise:
a request fetch circuit suitable for fetching an instruction of a read request from the memory to execute the read request;
a map search circuit suitable for searching for a physical address corresponding to a logical address for the read request from the memory;
a request order circuit suitable for arranging an execution order of the read request based on the physical address;
a command provider suitable for generating a read command for the memory device based on the arranged read request and the physical address;
a memory interface suitable for controlling a read operation of the memory device based on the read command and the physical address, and outputting read data that is from the memory device; and
an error correction code (ECC) decoder suitable for detecting and correcting an error of the read data.

6. The controller according to claim 5, wherein the map search circuit comprises:
a latest map search circuit suitable for searching for the physical address from a latest map list stored in the memory;
an unmap search circuit suitable for searching for the physical address from an unmap list stored in the memory; and
a map cache search circuit suitable for searching for the physical address from a map cache in the memory.

7. The controller according to claim 6, wherein, when the physical address is absent in the map cache, the map cache search circuit provides a map data read request and a physical address of a region where map data of the logical address is stored to a corresponding queue of the request order circuit to load the map data from the memory device.

8. The controller according to claim 7, wherein the map cache search circuit provides a read request indicating a cause for searching for the map data and the logical address to a corresponding queue of the request fetch circuit.

9. The controller according to claim 5, further comprising:
a logic block suitable for mapping a logical address to a physical address in response to a write request, generating a program command based on the write request, and providing the program command to the memory interface.

10. The controller according to claim 9, wherein the memory interface further controls a program operation of the memory device based on the program command and the physical address.

11. The controller according to claim 9,
wherein, when error correction of the read data succeeds, the ECC decoder stores error-corrected read data in the memory, and provides a data output request to the logic block, and
wherein the logic block outputs the error-corrected read data to an external device in response to the data output request.

12. The controller according to claim 11, wherein, when the error correction of the read data fails, the ECC decoder provides the read request and the physical address corresponding to the read data to the corresponding queue of the request order circuit.

13. The controller according to claim 1, wherein the pipeline manager comprises:
a power manager suitable for determining the available power; and
a queue manger suitable for determining a number of pipelining stages based on the available power and enabling the same number of queues as the number of pipelining stages among the plurality of queues.

14. A memory system, comprising:
a memory device; and
a controller suitable for controlling the memory device,
wherein the controller comprises:
a plurality of sub operation blocks suitable for performing sub operations of a request in a pipelining scheme;
a plurality of queues respectively corresponding to the plurality of sub operation blocks and suitable for queuing a plurality of requests that are associated with the sub operations; and
a pipeline manager suitable for selectively enabling each of the plurality of queues based on available power.

15. The memory system according to claim 14, wherein each of the plurality of queues queues an input signal in response to an enable signal from the pipeline manager, and transfers the input signal to a corresponding sub operation block among the plurality of sub operation blocks.

16. The memory system according to claim 14, wherein each of the plurality of queues directly transfers an input signal to a corresponding sub operation block without queuing the input signal in response to a disable signal from the pipeline manager.

17. The memory system according to claim 14,
wherein the controller further comprises a memory, and
wherein the plurality of sub operation blocks comprise:
a request fetch circuit suitable for fetching an instruction of a read request from the memory to execute the read request;
a map search circuit suitable for searching for a physical address corresponding to a logical address for the read request from the memory;
a request order circuit suitable for arranging an execution order of the read request based on the physical address;
a command provider suitable for generating a read command for the memory device based on the arranged read request and the physical address;
a memory interface suitable for controlling a read operation of the memory device based on the read command and the physical address, and outputting read data that is from the memory device; and
an ECC decoder suitable for detecting and correcting an error of the read data.

18. The memory system according to claim 14, wherein the pipeline manager comprises:
a power manager suitable for determining the available power; and
a queue manger suitable for determining a number of pipelining stages based on the available power and enabling the same number of queues as the number of pipelining stages among the plurality of queues.
